(19) United States
(12) Patent Application Publication
(10) Pub. No.: US 2019/0096040 A1
(43) Pub. Date: Mar. 28, 2019

(54) IMAGE PROCESSING APPARATUS, IMAGE PROCESSING METHOD AND NON-TRANSITORY READABLE STORAGE MEDIUM

(71) Applicants: KABUSHIKI KAISHA TOSHIBA, Tokyo (JP); TOSHIBA TEC KABUSHIKI KAISHA, Tokyo (JP)

(72) Inventor: Tomokazu Sakabe, Mishima Shizuoka (JP)

(21) Appl. No.: 15/713,921

(22) Filed: Sep. 25, 2017

(51) Int. Cl. G06T 5/00; G06T 1/00; G06K 9/78

(52) U.S. Cl. CPC G06T 5/005; G06K 2209/01; G06K 9/78; G06T 1/0007

(57) ABSTRACT

In accordance with an embodiment, an image processing apparatus comprises a scanner interface, a display section interface, and a processor. The scanner interface acquires a scanned image obtained by scanning a document. The display section interface communicates with a display. The processor generates a dropout image by deleting an area of a predetermined color from the scanned image and displays the dropout image and the scanned image on the display.

### FIELD

Embodiments described herein relate generally to an image processing apparatus, an image processing method and a non-transitory readable storage medium.

### BACKGROUND

An image processing apparatus acquires an image on a document using a scanner or the like. Such an image processing apparatus has a function (dropout color function) of generating an image obtained by deleting an area of a predetermined color from the acquired image.

Conventionally, there is a problem that the image processing apparatus cannot present whether the area of the predetermined color is appropriately deleted to the user.

### DESCRIPTION OF THE DRAWINGS

FIG. 1 is a block diagram exemplifying the constitution of an image processing apparatus according to an embodiment;

FIG. 2 is a diagram illustrating an example of a scanned image according to the embodiment;

FIG. 3 is a diagram illustrating an example of a dropout image according to the embodiment;

FIG. 4 is a diagram illustrating an example of an original image according to the embodiment;

FIG. 5 is a diagram illustrating an example of a deleted image according to the embodiment;

FIG. 6 is a diagram exemplifying the display on a display section according to the embodiment; and

FIG. 7 is a flowchart exemplifying the operation of the image processing apparatus according to the embodiment.

### DETAILED DESCRIPTION

In accordance with an embodiment, an image processing apparatus comprises a scanner interface, a display section interface, and a processor. The scanner interface acquires a scanned image obtained by scanning a document. The display section interface communicates with a display. The processor generates a dropout image by deleting an area of a predetermined color from the scanned image and displays the dropout image and the scanned image on the display.

Hereinafter, an embodiment is described with reference to the accompanying drawings.

An image processing apparatus according to the embodiment acquires a scanned image by scanning a document using a scanner. The image processing apparatus has a function (dropout color function) of generating an image by deleting an area of a predetermined color from the scanned image.

The image processing apparatus executes a processing (dropout processing) of deleting the area of the predetermined color from the scanned image. The image processing apparatus generates a file from the image (dropout image) obtained by the dropout processing. The image processing apparatus stores the file in a predetermined memory or transmits the file to an external device.

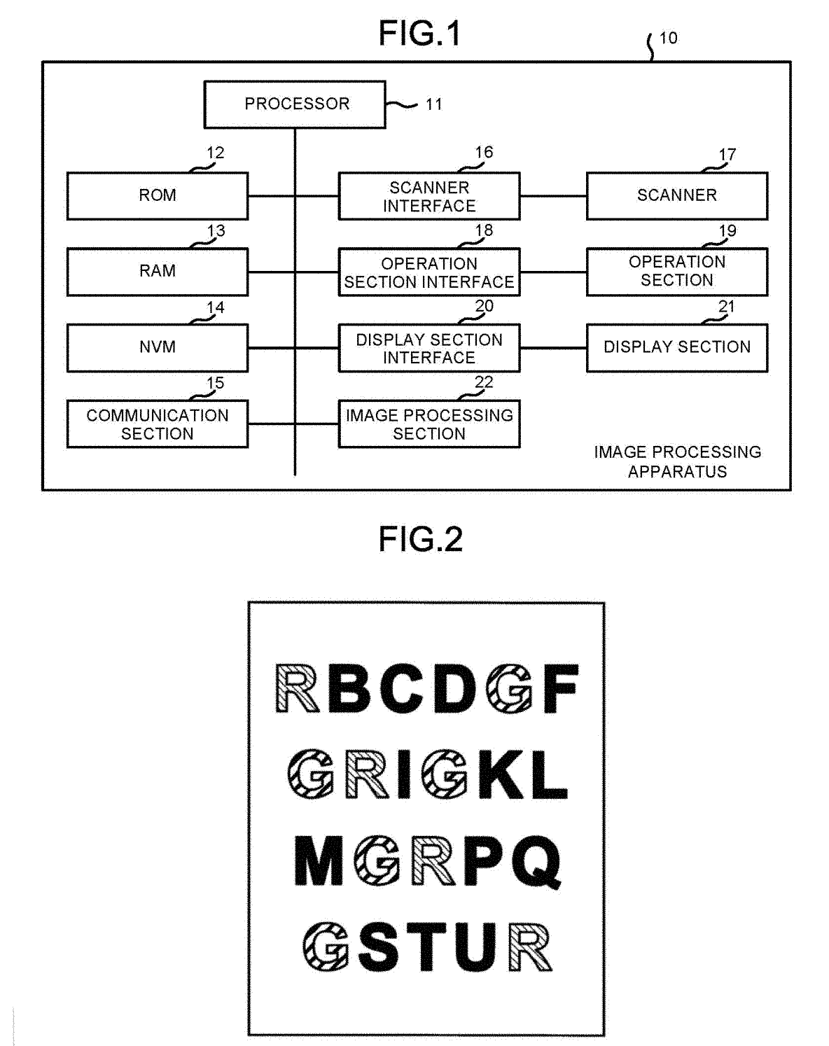

FIG. 1 is a block diagram exemplifying the constitution of an image processing apparatus 10 according to the embodiment.

As shown in FIG. 1, the image processing apparatus 10 includes, as basic constitution, a processor 11, a ROM 12, a RAM 13, a NVM 14, a communication section 15, a scanner interface 16, a scanner 17, an operation section interface 18, an operation section 19, a display section interface 20, a display section 21 and an image processing section 22.

The processor 11, the ROM 12, the RAM 13, the NVM 14, the communication section 15, the scanner interface 16, the scanner 17, the operation section interface 18, the display section interface 20 and the image processing section 22 are connected to one another via a data bus line.

The scanner interface 16 and the scanner 17 are connected to each other via a data bus line. The operation section interface 18 and the operation section 19 are connected to each other via a data bus line. The display section interface 20 and the display section 21 are connected to each other via a data bus line.

Furthermore, the image processing apparatus 10 may include a component other than the components shown in FIG. 1 as necessary, or exclude a specific component from those components.

The processor 11 has a function of controlling the operation of the whole image processing apparatus 10. The processor 11 may include an internal memory and various interfaces. The processor 11 realizes various processing by executing programs stored in the internal memory, the ROM 12 or the NVM 14 in advance.

Furthermore, a part of various functions realized by executing the programs by the processor 11 may be realized through a hardware circuit. In this case, the processor 11 controls the function realized by the hardware circuit.

The ROM 12 is a nonvolatile memory in which a control program and control data are stored in advance. The control program and control data stored in the ROM 12 are incorporated in advance according to specifications of the image processing apparatus 10. The ROM 12 stores, for example, a program for controlling a circuit substrate of the image processing apparatus 10.

The RAM 13 is a volatile memory. The RAM 13 temporarily stores data being processed by the processor 11. The RAM 13 stores various application programs based on a command from the processor 11. Moreover, the RAM 13 may store data necessary for executing the application program and an execution result of the application program.

The NVM 14 (non-transitory readable storage medium) is a nonvolatile memory capable of writing and rewriting data. The NVM 14 is, for example, a hard disk, an SSD, an EEPROM® technology or a flash memory. The NVM 14 stores a program, an application program and various data according to the operation and the application of the image processing apparatus 10.

The communication section 15 is an interface for transmitting and receiving data to and from an external device. For example, the communication section 15 is an interface that supports a LAN connection or a Bluetooth connection.

The scanner interface 16 is used for the processor 11 to communicate with the scanner 17. For example, the scanner interface 16 acquires the scanned image from the scanner 17. The scanner interface 16 transmits the acquired scanned image to the processor 11. Through the scanner interface 16, the processor 11 transmits a signal for enabling the scanner 17 to execute the scanning.

The scanner 17 reads a document in color based on a signal from the processor 11. For example, the scanner 17 scans the document set on a document table. For example, the scanner 17 may read the document by moving a sensor group arranged linearly. The scanner 17 may move a carriage that supplies light from the document to the sensor group. The constitution of the scanner 17 is not limited to a specific constitution.

The scanner 17 transmits the scanned image obtained by reading the document to the processor 11. The scanner 17 may store the scanned image in the RAM 13 or an image memory.

The operation section interface 18 is used for the processor 11 to communicate with the operation section 19. For example, the processor 11 receives a signal indicating the operation input to the operation section 19 through the operation section interface 18.

In the operation section 19, various operations are input by a user of the image processing apparatus 10. The operation section 19 transmits a signal indicating an operation input by the user to the processor 11. The operation section 19 is, for example, a keyboard, a numeric keypad or a touch panel. The operation section 19 may receive input of a gesture from the user.

The display section interface 20 is used for the processor 11 to communicate with the display section 21. For example, the processor 11 transmits a signal for enabling the display section 21 to display a screen through the display section interface 20.

The display section 21 is a display device for displaying an image output by the processor 11. The display section 21 is, for example, a liquid crystal display or the like.

If the operation section 19 is formed by a touch panel, the operation section 19 and the display section 21 may be integrally formed. The operation section 19 and the display section 21 may be integrally formed as a control panel. The operation section interface 18 and the display section interface 20 may be integrally formed.

The image processing section 22 executes various processing on the scanned image based on a signal from the processor 11. The image processing section 22 sets a processing executed on the scanned image based on the signal from the processor 11. The image processing section 22 acquires the scanned image from the processor 11. The image processing section 22 executes the processing on the scanned image according to the setting. The image processing section 22 transmits the image obtained by the processing to the processor 11.

The image processing section 22 executes a processing of deleting an area of a predetermined color from the scanned image. For example, the image processing section 22 determines the color in each dot of the scanned image. The image processing section 22 makes the dot into white if the color of the dot is the predetermined color. The image processing section 22 may make the dot into black. The image processing section 22 generates an image (dropout image) obtained by deleting the area of the predetermined color by executing the above processing in each dot. The image processing section 22 executes a processing of extracting the area of the predetermined color from the scanned image. In other words, the image processing section 22 generates an image (deleted image) of the area dropped out by the dropout processing.

For example, the image processing section 22 determines the color in each dot of the scanned image. The image processing section 22 may make the dot into the white if the color of the dot is different from the predetermined color. The image processing section 22 may make the dot into the black. The image processing section 22 generates the deleted image by executing the above processing in each dot.

The predetermined color may be a plurality of colors or may be black or white. The constitution of the predetermined color is not limited to a specific constitution.

The image processing section 22 executes a processing of changing the scanned image to a monochrome image.

The image processing section 22 may be constituted by, for example, an ASIC (application specific integrated circuit) or the like. The constitution of the image processing section 22 is not limited to a specific constitution.

Next, the function realized by the processor 11 is described. The following functions are realized by executing the program stored in the NVM 14 or the like by the processor 11.

First, the processor 11 has a function of acquiring the scanned image obtained by scanning the document in color.

For example, the processor 11 receives an operation to start scanning through the operation section 19. Here, the user sets the document on the document table of the scanner 17. The user inputs an operation to start the scanning to the operation section 19.

In a case of receiving the input of the operation, the processor 11 transmits a signal for enabling the scanner 17 to execute the scanning. The scanner 17 receives the signal and scans the document. The scanner 17 transmits the scanned image obtained by the scanning to the processor 11. The scanner 17 may store the scanned image in the RAM 13 or the image memory.

FIG. 2 shows an example of the scanned image. As shown in FIG. 2, the scanned image is constituted by images of alphabets. Here, it is assumed that “R” is red, “G” is green and other characters are black.

In addition, the processor 11 has a function of generating the dropout image obtained by deleting the area of the predetermined color from the scanned image.

The processor 11 sets a color (deleted color) of the deleted area. For example, the processor 11 receives the input of the color of the deleted area from the user through the operation section 19. The processor 11 may set a predetermined color as the color of the deleted area by default.

The processor 11 transmits a signal for instructing generation of an image in which the area of the set deleted color is deleted to the image processing section 22. The image processing section 22 sets itself according to the signal.

The processor 11 transmits the scanned image to the image processing section 22. The image processing section 22 generates the dropout image by processing the scanned image according to the setting. The image processing section 22 transmits the generated dropout image to the processor 11.

The processor 11 obtains the dropout image from the image processing section 22.

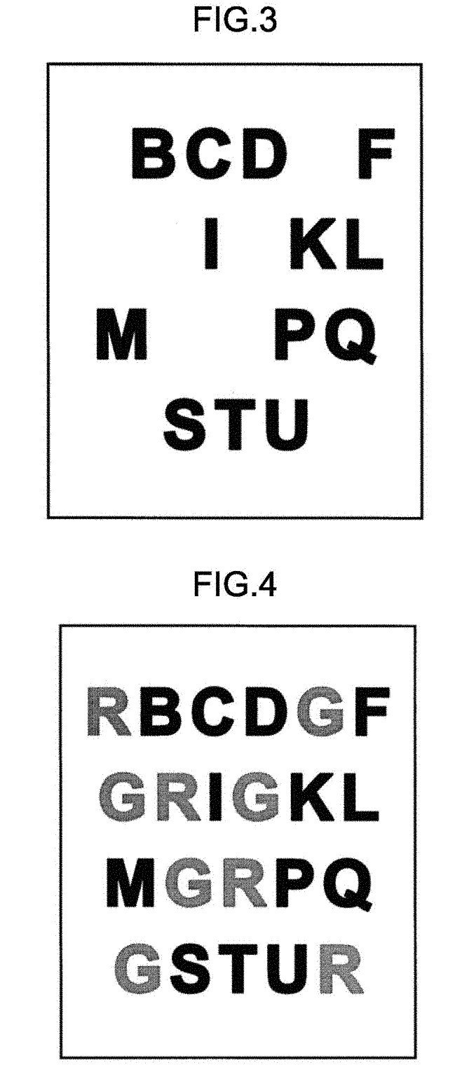

FIG. 3 shows an example of the dropout image. Here, it is assumed that the deleted color is a color having saturation (i.e., a color other than black, gray, and white). As shown in FIG. 3, the dropout image is an image obtained by deleting “R” which is red and “G” which is green. The dropout image is constituted by images of black characters.

In addition, the processor 11 has a function of generating an image (original image) for presenting the scanned image to the user.

The processor 11 generates an image through which the user can confirm the original document as an original image.

The processor 11 acquires an image obtained by making the scanned image into a monochrome image as an original image.

For example, the processor 11 transmits a signal instructing to generate the monochrome image to the image processing section 22. The image processing section 22 sets itself according to the signal.

The processor 11 transmits the scanned image to the image processing section 22. The image processing section 22 generates the monochrome image of the scanned image by processing the scanned image according to the setting. The image processing section 22 transmits the generated monochrome image to the processor 11.

The processor 11 acquires the monochrome image from the image processing section 22 as the original image.

FIG. 4 shows an example of the original image. As shown in FIG. 4, the original image is obtained by making the scanned image shown in FIG. 2 into the monochrome image. The original image can recognize each character on the original document. The original image is an image that allows the user to confirm the original document.

The processor 11 has a function of generating the deleted image by extracting the area of the predetermined color from the scanned image.

The processor 11 transmits a signal for instructing generation of an image obtained by extracting the set deleted color area to the image processing section 22. The image processing section 22 sets itself according to the signal.

The processor 11 transmits the scanned image to the image processing section 22. The image processing section 22 generates the deleted image by processing the scanned image according to the setting. The image processing section 22 transmits the generated deleted image to the processor 11.

The processor 11 acquires the deleted image from the image processing section 22.

The processor 11 makes the deleted image into the monochrome image. For example, the processor 11 transmits a signal instructing generation of the monochrome image to the image processing section 22. The image processing section 22 sets itself according to the signal.

The processor 11 transmits the deleted image to the image processing section 22. The image processing section 22 generates the monochrome image of the deleted image by processing the scanned image according to the setting. The image processing section 22 transmits the generated monochrome image to the processor 11.

The processor 11 acquires the monochrome image from the image processing section 22 as the deleted image.

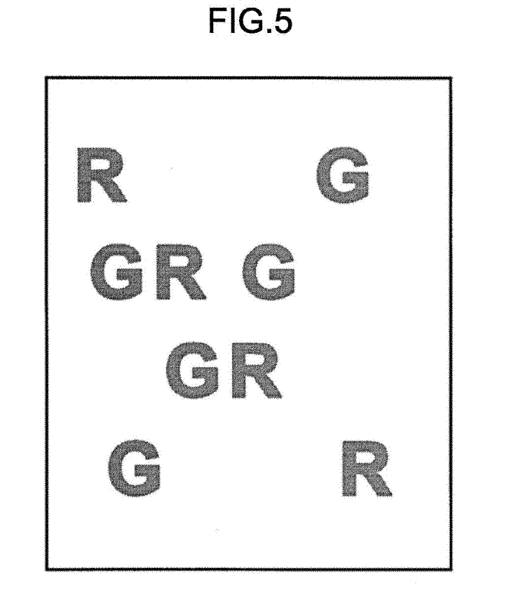

FIG. 5 shows an example of the deleted image. As described above, the deleted color is a color having saturation (i.e., a color other than black, gray, and white). As shown in FIG. 5, the deleted image is composed of “R” which is red and “G” which is green. The deleted image is an image obtained by deleting the black characters.

The processor 11 has a function of displaying the dropout image, the original image and the deleted image as a preview image.

The processor 11 displays the dropout image, the original image and the deleted image on the display section 21.

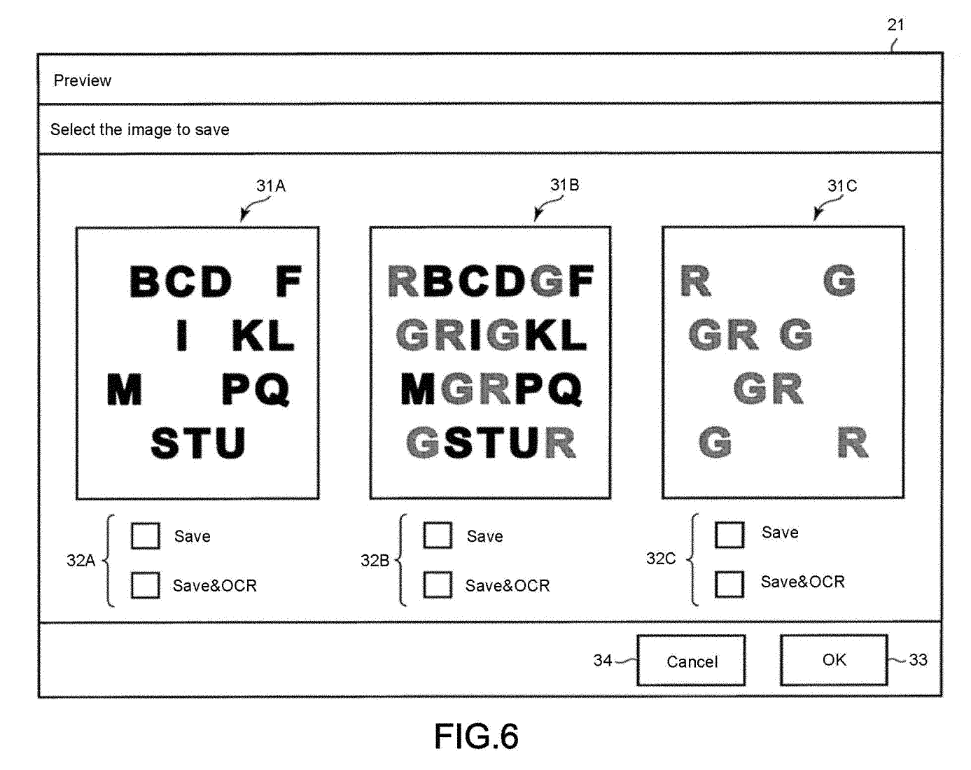

FIG. 6 shows an example of the image displayed by the display section 21. As shown in FIG. 6, the processor 11 sets display areas 31A to 31C. The processor 11 displays the dropout image in the display area 31A. The processor 11 displays the original image in the display area 31B. The processor 11 displays the deleted image in the display area 31C.

The processor 11 has a function of executing an OCR (Optical Character Recognition) processing on the dropout image, the original image and the deleted image.

The processor 11 receives selection of an image subjected to the OCR processing through the operation section 19. The processor 11 executes the OCR processing on the selected image. For example, the processor 11 executes the OCR processing by an image processing such as pattern recognition.

The processor 11 generates a file from the image subjected to the OCR processing and the result of the OCR processing. For example, the processor 11 generates a PDF file in which a character string read is embedded into the image.

The processor 11 may generate a file from the image without executing the OCR processing according to the operation input through the operation section 19.

The processor 11 has a function of storing the generated file.

For example, the processor 11 may store the generated file in the NVM 14. The processor 11 may store the file in a memory (such as a USB memory) set in the image processing apparatus 10. The processor 11 may transmit a file to an external device through the communication section 15.

In the example shown in FIG. 6, the processor 11 displays check boxes 32 (32A to 32C) for receiving an operation for inputting the selection of the stored image and presence or absence of the OCR processing. The check box 32A receives selection of storage of the dropout image or the OCR processing and the storage. The check box 32B receives the selection of the storage of the original image or the OCR processing and the storage. The check box 32C receives selection of the storage of the deleted image or the OCR processing and the storage.

The processor 11 displays an icon 33 for confirming the operation. In a case of receiving a touch on the icon 33, the processor 11 executes the OCR processing or storage of each image in accordance with the operation input to the check box 32.

The processor 11 displays an icon 34 for receiving an operation for canceling the input operation. In a case of receiving the touch on the icon 34, the processor 11 ends the operation.

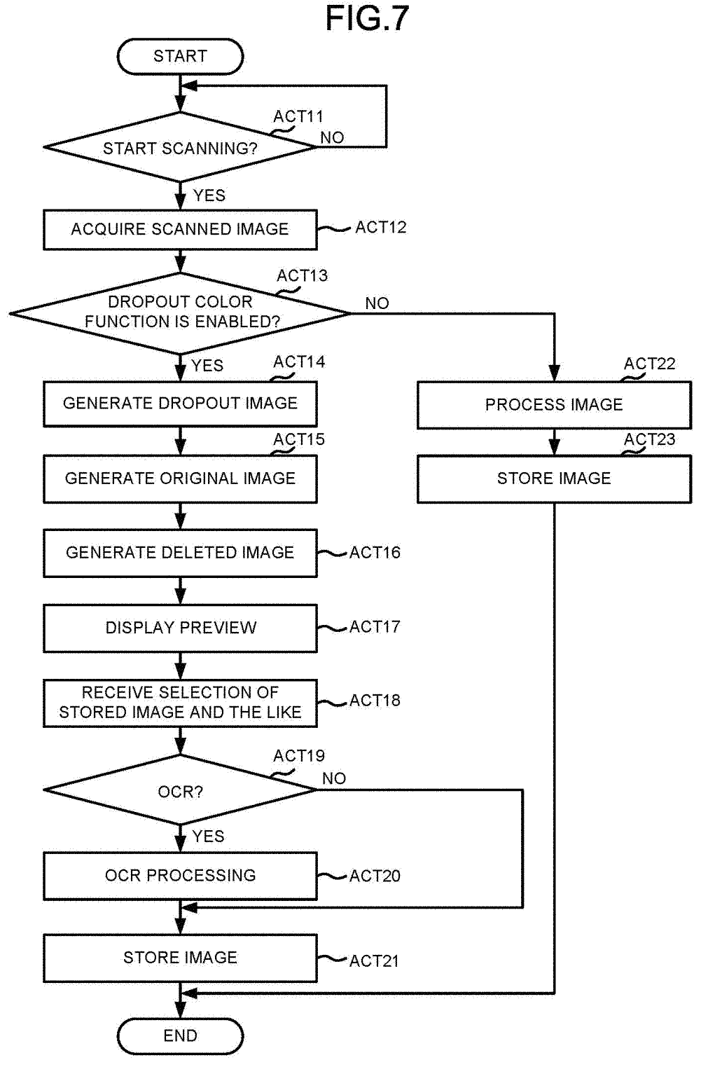

Next, an example of the operation of the image processing apparatus 10 is described. FIG. 7 is a flowchart exemplifying the operation of the image processing apparatus 10.

The processor 11 of the image processing apparatus 10 determines whether the operation to start the scanning is received through the operation section 19 (ACT 11). If it is determined that the operation to start the scanning is not received (No in ACT 11), the processor 11 repeats the processing in ACT 11.

If it is determined that the operation to start the scanning is received (Yes in ACT 11), the processor 11 acquires the scanned image from the scanner 17 (ACT 12). If the scanned image is acquired, the processor 11 determines whether the dropout color function is enabled (ACT 13). The processor 11 determines whether the dropout processing is executed on the scanned image. The processor 11 may determine whether the function of previewing the dropout image and the like or the function of selecting and storing the image is enabled.

If it is determined that the dropout color function is enabled (Yes in ACT 13), the processor 11 generates the dropout image from the scanned image using the image processing section 22 (ACT 14). If the dropout image is generated, the processor 11 uses the image processing section 22 to generate the original image from the scanned image (ACT 15).

If the original image is generated, the processor 11 uses the image processing section 22 to generate the deleted image from the scanned image (ACT 16).

If the deleted image is generated, the processor 11 displays the dropout image, the original image and the deleted image on the display section 21 as a preview (ACT 17). If the dropout image, the original image and the deleted image are displayed on the display section 21, the processor 11 receives the operation of inputting the selection of the stored image and the presence or absence of the OCR processing (ACT 18).

If the input operation of selecting the stored image and the presence or absence of the OCR processing is received, the processor 11 determines whether the input of the operation for executing the OCR processing is received (ACT 19). If it is determined that the input of the operation for executing the OCR processing is received, the processor 11 executes the OCR processing on the dropout image, the original image or the deleted image according to the input operation (ACT 20).

If it is determined that the input of the operation for executing the OCR processing is not received (No in ACT 19), or if the OCR processing is executed (ACT 20), the processor 11 generates the file from the dropout image, the original image or the deleted image and stores it in response to the input operation (ACT 21).

If it is determined that the dropout color function is not enabled (No in ACT 13), the processor 11 processes the scanned image according to the set processing content (ACT 22). After processing the scanned image, the processor 11 generates the file from the scanned image and stores it (ACT 23).

If the file is generated from the image and stored according to the input operation (ACT 21), or if the file is generated from the scanned image and stored (ACT 23), the processor 11 ends the operation.

The processor 11 does not have to generate the deleted image.

The processor 11 may generate a color image as the original image. For example, the processor 11 may use the scanned image as the original image. The processor may display the scanned image as a preview image.

The processor 11 may generate a color image as the deleted image. For example, the processor 11 does not have to execute the operation of making the deleted image into the monochrome image.

The processor 11 may realize the function of the image processing section 22. For example, the processor 11 may realize the function of the image processing section 22 by executing a program stored in the NVM 14 or the like.

The image processing apparatus 10 may include a printer for printing an image on a paper. The image processing apparatus 10 may print the dropout image, the original image or the deleted image according to the operation from the user.

The image processing apparatus constituted as described above displays the dropout image generated by the dropout processing and the original image indicating the original document from the scanned image. Therefore, the image processing apparatus can present how the original document changes by the dropout processing to the user. As a result, the image processing apparatus can present whether the predetermined color is properly deleted to the user.

The image processing apparatus displays the deleted image indicating the deleted area of the predetermined color. Therefore, the image processing apparatus can present the area deleted by the dropout processing to the user.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image processing apparatus, comprising:
a scanner interface configured to acquire a scanned image obtained by scanning a document;
a display section interface configured to communicate with a display; and
a processor configured to generate a dropout image by deleting an area of a predetermined color from the scanned image and display the dropout image and the scanned image on the display.

2. The image processing apparatus according to claim 1, wherein
the processor generates a monochrome image from the scanned image and displays the monochrome image as the scanned image on the display.

3. The image processing apparatus according to claim 1, wherein
the processor generates the deleted image by extracting the area of the predetermined color and displays the deleted image on the display.

4. The image processing apparatus according to claim 3, wherein
the deleted image is monochrome.

5. The image processing apparatus according to claim 4, wherein
the processor executes an OCR processing on the dropout image, the scanned image or the deleted image.

6. The image processing apparatus according to claim 1, further comprising:
an image processing section configured to generate the dropout image from the scanned image, and
the processor generates the dropout image using the image processing section.

7. The image processing apparatus according to claim 1, further comprising:
a scanner configured to scan the document to generate the scanned image.

8. The image processing apparatus according to claim 1, further comprising:
a display.

9. An image processing method, including:
acquiring a scanned image obtained by scanning a document,
generating a dropout image by deleting an area of a predetermined color from the scanned image, and
displaying the dropout image and the scanned image on a display.

10. A non-transitory readable storage medium sorting a program for enabling a processor to
acquire a scanned image obtained by scanning a document,
generate a dropout image by deleting an area of a predetermined color from the scanned image, and
display the dropout image and the scanned image on a display.
